(19) United States
(12) Patent Application Publication
(10) Pub. No.: US 2020/0258019 A1
(43) Pub. Date: Aug. 13, 2020

(54) COMPONENT COST SHEET (CCS) TOOL

(71) Applicant: Walmart Apollo, LLC, Bentonville, AR (US)

(72) Inventors: Arvind Nathan, Bentonville, AR (US); Mani Kanteswara Rao Garlapati, Bangalore (IN)

(21) Appl. No.: 16/365,299

(22) Filed: Mar. 26, 2019

(30) Foreign Application Priority Data
Feb. 12, 2019 (IN) 201941005422

(51) Int. Cl. G06Q 10/06; G06Q 30/06

(52) U.S. Cl. CPC G06Q 10/06315; G06Q 30/0611

(57) ABSTRACT

Systems and methods are disclosed that enable efficient management of requests for quotations (RFQs) on a large scale. Component cost sheets (CCSs) are used, which are exchanged between a sourcing function in a retailer or distributor organization and multiple suppliers (vendors). A CCS tool receives RFQ data, for example from a user; generates a CCS; transmits the CCS to at least one supplier; and based at least on information entered into the CCS by the supplier, generates a comparison of current product information with historical product information. By having the comparison available, negotiation between sourcing and the supplier is facilitated. For example, the CCS tool can generate a request for an updated CCS, with a reduced cost, and transmit it to the supplier for consideration.

### BACKGROUND

When a distributor or retailer performs sourcing, the process is typically labor-intensive and subject to error, due to reliance on manual processes. The problems become exacerbated for large-scale operations involving large numbers of products and a large set of suppliers, and even more so when many products are each sourced from many different suppliers. For example, if a supplier raises prices on a product, this may go unnoticed by the sourcing organization, with a manual process, due to the sheer volume of different forms and documents. Additionally, if a supplier, that has historically provided products at a good price, fails to respond to a request for quotation (RFQ) in a timely manner, this may also go unnoticed, resulting in selection of a higher-priced supplier.

### SUMMARY

Systems and methods are disclosed that enable efficient management of requests for quotations (RFQs) on a large scale, using unconventional methods. Component cost sheets (CCSs) are used, which are exchanged between a sourcing function in a retailer or distributor organization and multiple suppliers (vendors). A CCS tool receives RFQ data, for example from a user; generates a CCS; transmits the CCS to at least one supplier; and based at least on information entered into the CCS by the supplier, generates a comparison of current product information with historical product information. By having the comparison available, negotiation between sourcing and the supplier is facilitated. For example, the CCS tool can generate a request for an updated CCS, with a reduced cost, and transmit it to the supplier for consideration.

A disclosed tool comprises a processor; and a computer-readable medium storing instructions that are operative when executed by the processor to: receive RFQ data; determine whether the received RFQ corresponds with prior RFQ data; based at least on the received RFQ not corresponding with prior RFQ data, generate a new sourcing identification value (GSID); based at least on the RFQ data, generate a CCS referencing the GSID;; transmit the CCS to at least one remote node across a computer network; receive a completed copy of the CCS containing current product information; store the completed CCS in a data store; and based at least on the current product information in the completed CCS, generate a comparison of the current product information with historical product information.

### BRIEF DESCRIPTION OF THE DRAWINGS

The disclosed examples are described in detail below with reference to the accompanying drawing figures listed below:

FIG. 1 illustrates the creation of component cost sheets (CCSs);

FIG. 2A shows an example supplier CCSs (sCCS) template;

FIG. 2B shows an example global sourcing CCS (GSCCS) template;

FIG. 3 shows an example architecture for an automated CCS environment that can make advantageous use of the CCSs of FIG. 1;

FIG. 4 shows an example requests for quotations (RFQ) data input screen, useable with the architecture of FIG. 3;

FIG. 5 shows an example RFQ message that is transmitted in the automated CCS environment of FIG. 3;

FIG. 6 shows an example sCCS in spreadsheet form, awaiting completion;

FIG. 7 shows an example comparison of current product information with historical product information;

FIG. 8 shows a flow chart illustrating exemplary unconventional operations involved in managing RFQs using CCSs that may be used with the architecture of FIG. 3; and

FIG. 9 is a block diagram of an example computing device for implementing aspects disclosed herein.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity of presentation, this implied leading clause is not repeated ad nauseum.

When a distributor or retailer performs sourcing, the process is typically labor-intensive and subject to error, due to reliance on manual processes. The problems become exacerbated for large-scale operations involving large numbers of products and a large set of suppliers, and even more so when many products are each sourced from many different suppliers. For example, if a supplier raises prices on a product, this may go unnoticed by the sourcing organization, with a manual process, due to the sheer volume of different forms and documents. Additionally, if a supplier, that has historically provided products at a good price, fails to respond to a request for quotation (RFQ) in a timely manner, this may also go unnoticed, resulting in selection of a higher-priced supplier.

Therefore, unconventional systems and methods are disclosed that enable efficient management of RFQs on a large scale, for example by reducing certain classes of labor time by up to 70% and reducing the risk of human error. Component cost sheets (CCSs) are used, which are exchanged between a sourcing function in a retailer or distributor organization and multiple suppliers (vendors). A CCS tool receives RFQ data, for example from a user; generates a CCS; transmits the CCS to at least one supplier; and based at least on information entered into the CCS by the supplier, generates a comparison of current product information with historical product information. By having the comparison available, negotiation between sourcing and the supplier is facilitated. For example, the CCS tool can generate a request for an updated CCS, with a reduced cost, and transmit it to the supplier for consideration.

The novel CCS tool advantageously simplifies sourcing functions and supplier responses, for example by reducing CCS management labor time by 70%. The CCS tool includes RFQ functionality, tracks RFQs and responses, and facilitates negotiations with suppliers by automatically retrieving relevant data for comparison, generating requests for updated CCSs, and transmitting the requests for updated CCSs. With some examples, users can generate an RFQ, populate a list of multiple bidders (e.g., potential suppliers), and transmit the RFQs to all of the multiple bidders with a single click—without the need to draft correspondence with each of the multiple bidders. Negotiations (e.g., requests for better prices) can be managed with similar ease.

Some examples facilitate negotiation with multiple bidding vendors for individual supply styles, by linking Last Year (LY) and Last Season (LS) information with This Year (TY) information. Automatic retrieval of LY and LS styles based on TY style numbers relieves users from searching for the information manually. Some examples create audit schema in an SQL server to track inbound and outbound email conversations. A tracking and audit tool ensures RFQs are sent and that supplier CCSs (sCCSs) are received, stored properly, and processed. In general, a CCS provides cost transparency on the components of a product, allowing cost comparison between new styles and previous styles. Thus, a CCS can be a source for analytics. Examples of the novel CCS tool provide the ability to automatically link LS and LY styles with a TY style number using an identification value. In some examples, the identification value depends on the distribution market, a user ID, and the target supplier market. An automatic standardized process sending emails to suppliers for RFQs. An entire team may be kept appraised of RFQ status via group messages. Thus, examples are capable of processing a high volume of sCCSs.

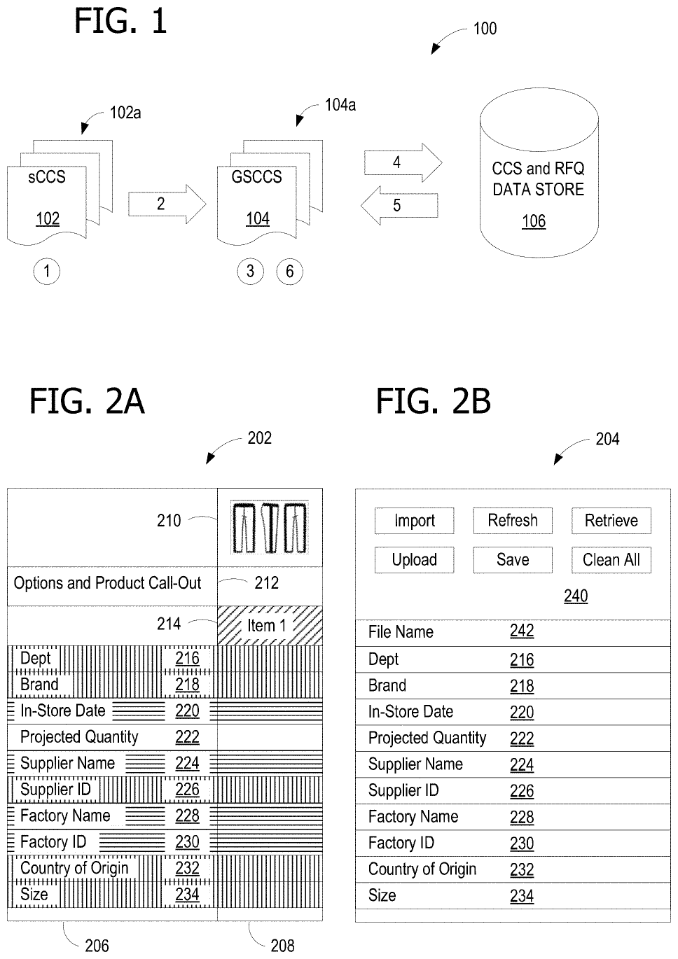

FIG. 1 illustrates the creation of CCSs, specifically the creation of a global sourcing CCS (GSCCS) 104 from an sCCSs 102 in a multi-stage workflow 100. Further detail is provided regarding an sCCSs template 202 and a GSCCS template 204 in FIGS. 2A and 2B, respectively. In stage 1, a set of sCCSs 102a is edited or created by vendors (potential suppliers), possibly based on a template, and submitted to a global sourcing (GS) organization in stage 2. The GS organization (GSO) uses a tool to imports set of sCCSs 102a from various sources, validates set of sCCSs 102a against GS criteria, and generates a set of GCCSs 104a . In stage 4, the GSO uploads the set of GCCSs 104a, and other relevant CCS-related data to a CCS and RFQ data store 106. The set of GCCSs 104a may then be refreshed in stage 5 to update any GSCCS worksheets. TY, LY, and LS data is retrieved from CCS and RFQ data store 106 and used to populate set of GCCSs 104a.

FIG. 2A shows an example sCCS template 202 that may be used as a basis for creating sCCSs 102 of FIG. 1, and FIG. 2B shows an example GSCCS template 204 that may be used as a basis for converting sCCSs 102 into GSCCS 104 of FIG. 1. The illustrated example of sCCS template 202 has a label column 206 for data labels and a data column 208 for product-specific information. Other examples of sCCS template 202 will have additional data columns 208 for product-specific information regarding additional products. At the top of sCCS template 202, there is a product image 210, and the row below is an option and product call-out row 212. A completion indicator 214, shaded with diagonal lines, is a logical function cell that can change colors (e.g., from red to green) when all of the required information in data column 208 is filled in.

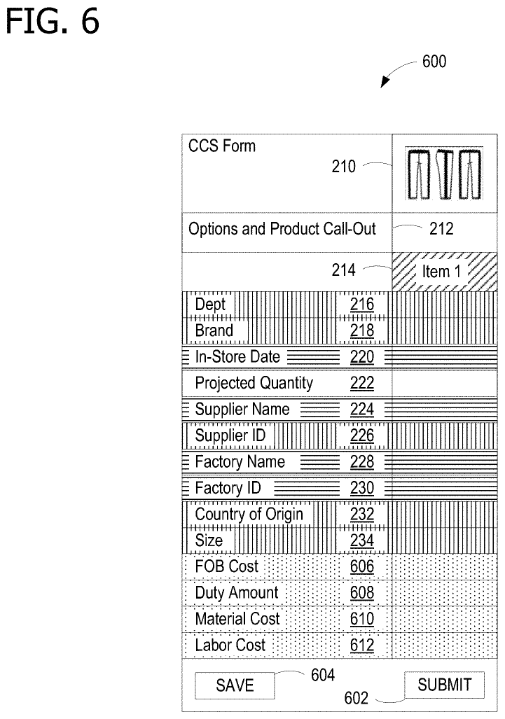

Some example data labels are shown in label column 206 indicating data rows for department 216, brand 218, in-store date 220, projected quantity 222, supplier name, 224, supplierID 226 (an identification number for the supplier), factory name 228, factoryID 230 (an identification number for the factory), country of origin 232, and product size 234. Other examples of sCCS template 202 will have a different set of data rows, some including additional data rows. A larger list of example data rows is provided in the description of FIG. 6. The illustrated example GSCCS template 204 has a common set of data rows 216-234, and includes a graphical user interface (GUI) section 240 and a file name data row 242. GUI section 240 includes user-actuated GUI buttons for various operations involved with creating and editing a GSCCS, such as importing data (for conversion), refreshing data, retrieving stored data, uploading data, saving data, and clearing data (“clean all”).

Data rows 216, 218, 226, 232, and 234 are shaded with vertical lines, indicating that the row has a mandatory data field, with a drop-down menu for user selection of the contents. Data rows 220, 224, 228, and 230 are shaded with horizontal lines, indicating mandatory cells in which a user types information. Data row 222 has no shading, indicating that it is optional. In some examples, rather than shading with lines, the different rows are color coded, for example with yellow and orange.

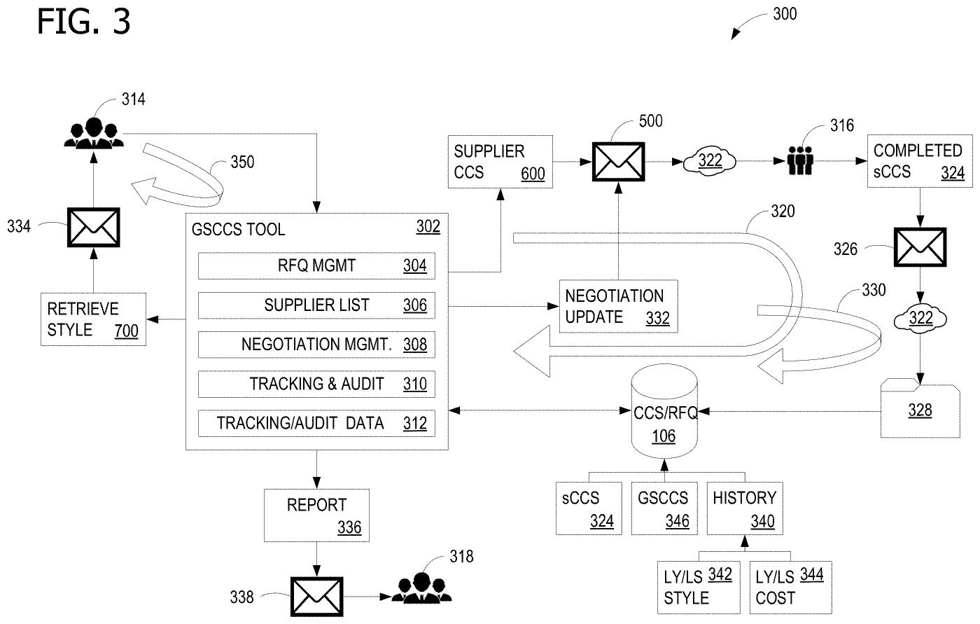

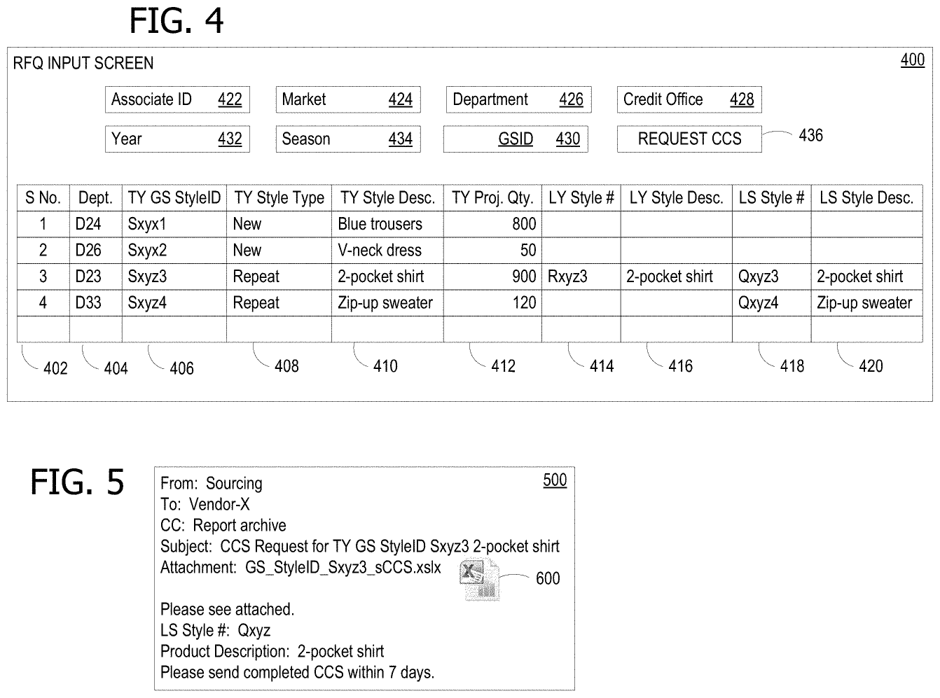

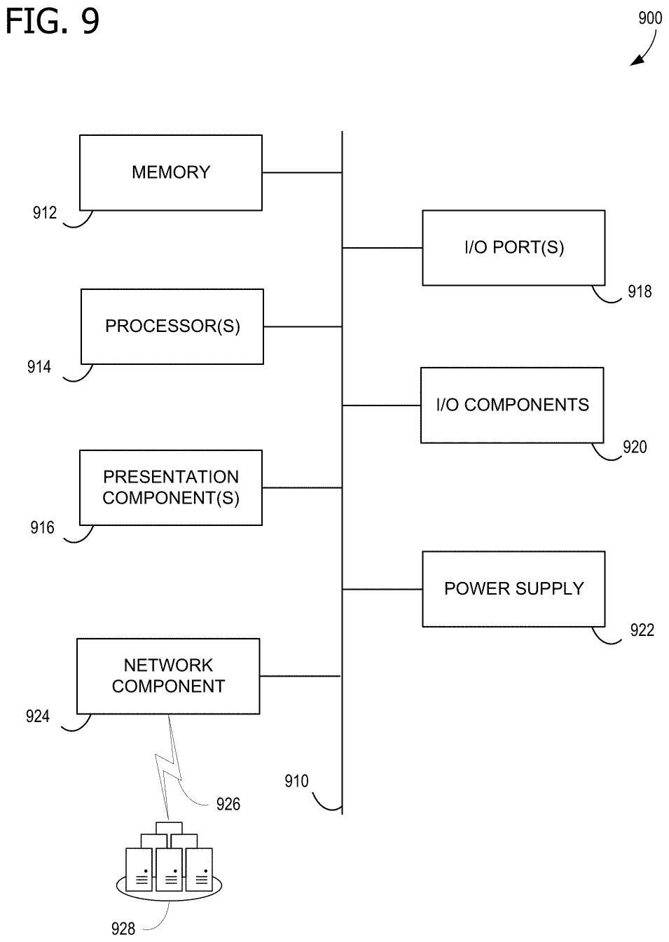

FIG. 3 shows an example architecture 300 for an automated CCS environment that can make advantageous use of the CCSs (sCCS 102 and GSCCS 104) of FIG. 1. A CCS tool, specifically GSCCS tool 302, runs on at least one processor (see FIG. 9) and is stored in a computer-readable medium, including both data and instructions that are operative, when executed by the processor, to perform operations described herein. A user 314 within the GSO uses GSCCS tool 302 to generate RFQs by providing RFQ data into RFQ management function 304 of GSCCS tool 302. An example RFQ data input screen 400, presented to user 314 by RFQ management function 304, is illustrated in FIG. 4. Based at least on the RFQ data received (e.g., input by user 314), RFQ management function 304 generates a supplier CCS (sCCS 600) with blank fields to be completed by each bidding vendor (e.g., a potential supplier). More detail on sCCS 600 is provided in FIG. 6.

RFQ management function 304 automatically generates a set of multiple email messages 500, and uses a supplier list 306 to populate the recipient field of each message 500. More detail on message 500 is provided in FIG. 5. RFQ management function 304 transmits sCCS 600 to at least one remote node 316 across a computer network 322. Remote node 316 represents a bidding vendor. The bidding vendor completes sCCS 600 with current product information and submits it. Some examples of sCCS 600 include a submit button 602 (see FIG. 2) that automatically generates an email message 326 and attaches a copy of the completed sCCS 324. Message 326 is received and stored in a shared folder 328. Data from message 326 is retrieved from shared folder 328 and used by GSCCS tool 302. For example, completed sCCS 324, containing the current product information, is stored in CCS and RFQ data store 106 along with other GSCCS information 346. The reception of message 326 is also tracked by tracking and audit function 310, which tracks CCS responses from the remote nodes 316 to which copies of sCCS 600 were sent. This permits sending reminders to late-responding bidding vendors, to ensure that all potential suppliers have a chance for consideration.

The workflow from RFQ management function 304 in GSCCS tool 302, through the generation of sCCS 600, the transmittal of message 500 across network 322 to remote node 316, the submission of completed sCCS 324 via message 326 to shared folder 328, the storage in CCS and RFQ data store 106, and the tracking by tracking and audit function 310 in GSCCS tool 302 forms an initial RFQ loop 320. Historical product information 340, from prior RFQs and CCSs, is also stored within CCS and RFQ data store 106. Historical product information 340 includes, for example, LY and LS style information 342 that includes a product description for various products from last year and/or last season. Historical product information 340 also includes, for example, LY and LS cost information 344 that includes cost information for various products from last year and/or last season.

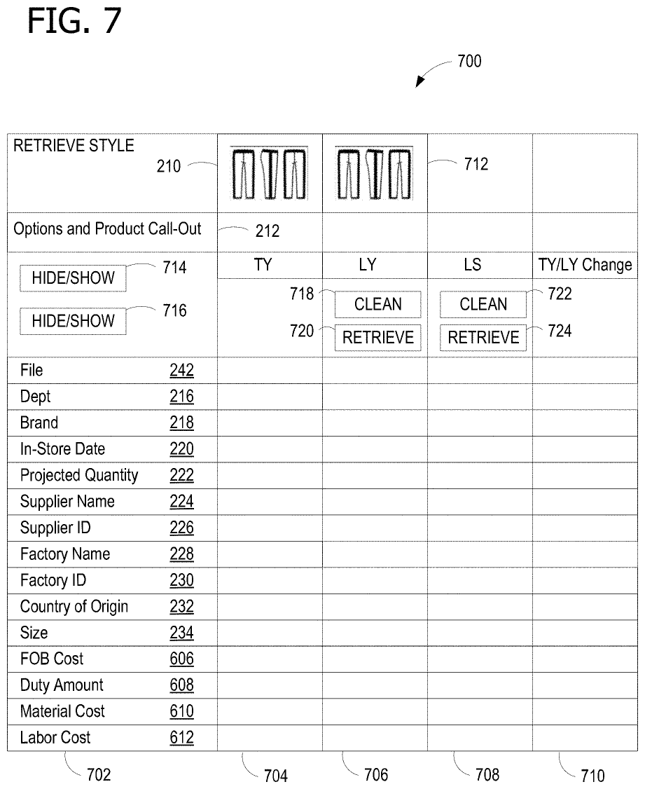

When tracking and audit function 310 has identified that RFQ responses are in, GSCCS tool 302 can then alert user 314 to examine the incoming RFQ responses (bids). Based at least on the current product information in completed sCCS 324, and GSCCS tool 302 generates a comparison of the current product information with historical product information in the form of a retrieve style screen 700. More detail on retrieve style screen 700 is provided in FIG. 7. In order to populate retrieve style screen 700 with the necessary information, GSCCS tool 302 links the current product information with historical product information. In some cases, this linking is performed using an ID value, specifically, a GS identification value (GSID) 430. In some cases, this linking is performed using a product description, specifically, information in a TY Style Description field 410 and information in a LY Style Description field 416 or a LS Style Description field 420. More detail on GS identification value (GSID) 430, TY Style Description field 410, information in a LY Style Description field 416, and LS Style Description field 420 is provided in FIG. 4.

Retrieve style screen 700 is presented to user 314. In some examples, GSCCS tool 302 generates an alert 334 (e.g., an email message) to instruct user 314 to examine retrieve style screen 700. In some examples, alert 334 is a group email message, received by multiple users 314 or a sourcing team. Based at least on the information presented in retrieve style screen 700, user 314 has access to information relevant for negotiating with the bidding vendor. For example, perhaps the bidding vendor doubled the price of a product. User 314 is able to see this readily on retrieve style screen 700 without having to go dig up the information manually. User 314 then uses negotiation management function 308 in GSCCS tool 302 to transmit a negotiation update 332, for example, a request for an updated CCS, by sending another automatically-generated message 500 to remote node 316 across computer network 322. When the bidding vendor at remote node 316 submits an updated completed sCCS 324 to shared folder 328, tracking and audit function 310 logs the receipt of additional message 326 and sCCS 324. In some examples, when tracking and audit function 310 identifies the receipt of the additional message 326, GSCCS tool 302 generates another alert 334 to user 314.

The workflow from negotiation management function 308 in GSCCS tool 302, through the generation of negotiation update 332, the transmittal of message 500 across network 322 to remote node 316, the submission of updated completed sCCS 324 via message 326 to shared folder 328, the storage in CCS and RFQ data store 106, and the tracking by tracking and audit function 310 in GSCCS tool 302 forms a negotiation loop 330. Negotiation loop 330 may be repeated until user 314 accepts a bid from a supplier. An RFQ management loop 350 includes user interfacing with GSCCS tool 302 to generate the initial RGQ and handle negotiations with bidders, and receiving alerts 334 to view retrieve style screens 700. At various points within loops 320, 330, and 350, GSCCS tool 302 generates a report 336 and sends a message 338, such as an email message with report 336 as an attachment, to a supervisory or other monitoring node 318. For example, when GSCCS tool 302 transmits message 500, GSCCS tool 302 may also generates report 336 and sends message 338, with report 336 as an attachment, to supervisory node 318.

FIG. 4 shows example RFQ data input screen 400, presented to user 314 by RFQ management function 304. RFQ data input screen 400 enables user 314 to generate RFQs with CCSs with a single click of a Request CCS button 436. The illustrated RFQ data input screen 400 includes multiple columns, including a style row number 402, a department field 404, a TY GS StyleID field 406, a TY style type field 408, TY Style Description field 410, a TY projected quantity field 412, an LY style number field 414, LY Style Description field 416, an LS style number field 418, and LS Style Description field 420. Some examples of RFQ data input screen 400 have additional fields and columns.

Style row number 402 is automatically filled as user 314 enters information and adds data in new rows. Department field 404 indicates a code for a sales or store department. Values in TY GS StyleID field 406 may be automatically generated and unique for each row in RFQ data input screen 400. TY style type field 408 indicates whether a particular product style is new or repeated. If the product is new, there may not be any historical product information available. However, if TY style type field 408 indicates that it is a repeat style, then historical information will be located and used to populate the relevant column fields in the same row, for example LY style number field 414, LY Style Description field 416, an LS style number field 418, and LS Style Description field 420.

TY Style Description field 410 contains a description of the product style, which may be used to locate historical information, such as by matching the content of TY Style Description field 410 with LY and LS information within CCS and RFQ data store 106 and link it to the current product information. For example, note that “2-pocket shirt” in TY Style Description field 410 also appears in LY Style Description field 416 and LS Style Description field 420, and “Zip-up sweater” in TY Style Description field 410 also appears in LY Style Description field 416 and LS Style Description field 420. Note also that, for the repeated product styles, LY style number field 414 and LS style number field 418 show different values than each other and TY GS StyleID field 406. In some examples, this may not be not the case.

In operation, user 314 populates associate ID 422, distribution market field 424, department field 426, and credit office 428. Based at least on these inputs, an ID value, specifically GSID 430, is generated, if any of the data is new. If, however, associate ID 422, distribution market field 424, department field 426, and credit office 428 correspond with prior-existing information that is already associated with a prior-existing GSID 430, then that prior-existing GSID 430 value is reused. In examples involving reusing GSID 430, GSID 430 can be used to find historical product information within CCS and RFQ data store 106 and link it to the current product information. User 314 also populates year field 432 and season field 434. When RFQ data input screen 400 is complete, user 314 clicks Request CCS button 436. GSCCS tool 302 then automatically generates message 500, attaches sCCS 600 and sends it to recipients indicated in supplier list 306 and/or a preferred vendor field (not shown) in RFQ data input screen 400.

FIG. 5 shows example RFQ message 500 that is transmitted at least one remote node 316 across computer network 322. As indicated, a bidding vendor (potential supplier), identified as “Vendor-X” is addressed, and a copy of sCCS 600 is attached. In the illustrated example, sCCS 600 is an xlsx formatted spreadsheet.

FIG. 6 shows example sCCS 600 in spreadsheet form, awaiting completion by bidders. When completed, sCCS 600 will become completed sCCS 324 of FIG. 3, and contains cost information related to the bidder's quote. Specifically, a user, such as a bidder at remote node 316, enters information in mandatory data rows 216, 218, 226, 232, and 234 using a drop-down menu, and also mandatory data rows 220, 224, 228, and 230. The user can also enter information into optional data row 222. Data rows FOB cost 606, duty amount 608, material cost 610, and labor cost 612 are shaded with dots, indicating that these rows contain formula cells. In some examples, data rows with formula cells, such as 606, 608, 610, and 612 will be color coded, for example with green.

For the data rows with formula cells, the values are calculated using other values in sCCS 600, rather than directly input by a user. When all of mandatory data rows 216, 218, 220, 224, 226, 228, 230, 232, and 234 are completed, completion indicator 214, which is a logical function cell, changes colors (e.g., from red to green), to indicate that a submit button 602 is activated and can be used to generate message 326 of FIG. 3. Alternatively, the user can save a partially-filled copy of sCCS 600, using a save button 604, for later completion and submission.

Examples of possible data rows for some examples of sCCS 600 include: Product Info; Department; Brand; Season; Style #; Style Option; Product Description; Sub Category; Size; Credit Office; Supplier Name; SupplierlD; Factory Name; FactorylD; Material Info; Fabric Info; Fabric Cost; Fabric Usage; Fabric Wastage; Trim Info; Trim Cost; Packaging Info; Packaging Cost; Technique Cost; Wash Cost; Logistics Info; First FOB Cost; Store Cost; Warehouse Sell Cost; Duty Rate %; Duty Amount$ /Unit; Total Duty Amount; 9 Digit Freight Factor; Other Costing Factors; Port Of Loading; Country Of Origin; Trade Agreement; Cost Validity Date

FIG. 7 shows an example retrieve style screen 700 that provides a comparison of current product information with historical product information for user 314. Retrieve style screen 700 includes multiple columns, including a label column 702 for data labels, a TY product information column 704, an LY product information column 706, an LS product information column 708, and TY/LY change column 710. TY/LY change column 710 can provide user 314 with a ready comparison of price change information between last year and this year, for example by looking at FOB cost data row 606 of TY/LY change column 710. Some examples retrieve style screen 700 also have a TY/LY change column to provide user 314 with a ready comparison of price change information from last season. Some examples retrieve style screen 700 have additional fields and columns.

Option and product call-out row 212 provides a location for additional information in each of columns 704-710, for example a description of the difference between the product represented by that particular column and a product represented by another column. A product image 210 is shown at the top of TY product information column 704, and a last year's product image 712 is shown at the top of LY product information column 706. User controls hide/show buttons 714 and 716 enable user 314 to toggle display of various categories of information. User controls also include a clean button 718 and a retrieve button 720 in LY product information column 706, and a clean button 722 and a retrieve button 724 in LS product information column 708. Clean buttons 718 and 722 cause GSCCS tool 302 to clear out the contents of the respective columns, and retrieve buttons 720 and 724 cause GSCCS tool 302 to retrieve historical product information to populate the respective columns.

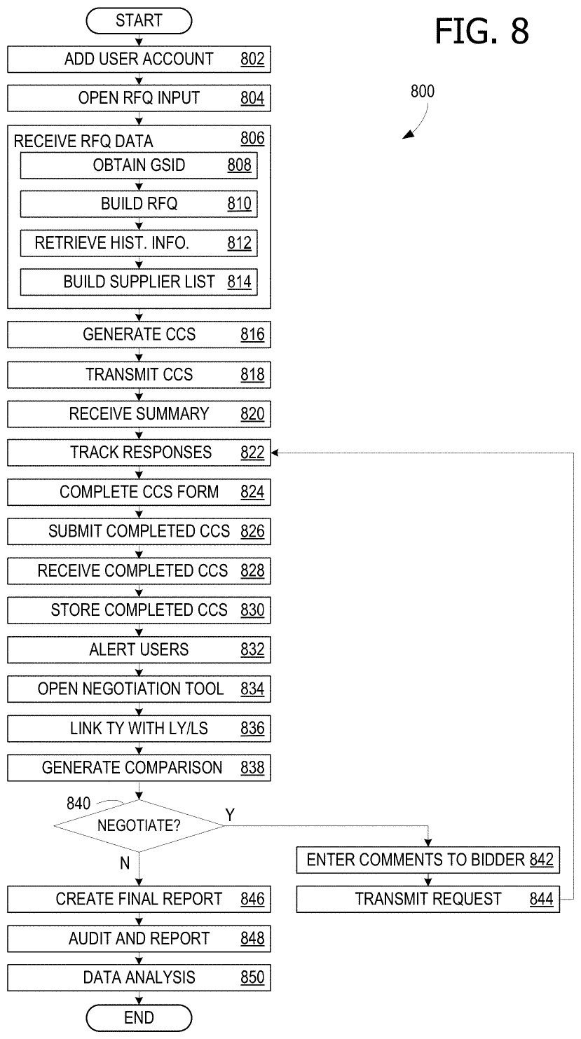

FIG. 8 shows a flow chart 800 illustrating exemplary operations involved in using GSCCS tool 302 (of FIG. 3) for managing RFQs using CCSs in an unconventional manner. A new user is assed to the CCS tool (e.g., GSCCS tool 302) in operation 802, and obtains a user ID number (e.g., associate ID 422 of FIG.4). In operation 804, the user opens the RFQ management function, to view the RFQ data input screen. Operation 806 includes the CCS tool receiving RFQ data, with the set of operations 808-814. For example, in operation 808 a GSID is obtained. Either a new GSID is generated via user inputs such as an associate ID, a distribution market, and other information, or a GSID from a prior year's or prior season's RFQ is used. If the current (TY) received RFQ data is the same as the prior year's or season's (LY, LS) RFQ data, then the prior-existing GSID is used, so that a comparison can be made. The RFQ data used for this correspondence determination includes one or more of associate ID, distribution market field, department field, and credit office. (See the description of FIG. 4.) If, however the current (TY) associated RFQ data does not correspond with the prior year's or season's (LY, LS) RFQ data, to warrant reusing a prior-existing GSID then a new GSID is generated. Thus, operation 808 includes determining whether the received RFQ corresponds with prior RFQ data, and based at least on the received RFQ not corresponding with prior RFQ data, generating a new GSID.

In operation 810, the user provides further necessary details in the RFQ data input screen to initiate a request to bidders. The user is required to enter the mandatory details such as market, department, credit office, year and season, as well as indicate the information needed from the bidders. In operation 812 historical product information is retrieved (e.g., LY and LS style information), if available, and used to populate the relevant portions of the RFQ data input screen. The user can add or edit bidder information in a supplier list (e.g., put email addresses into supplier list 306) to ensure that automatically generated RFQ messages are sent to the desired se of bidders, in operation 814. Operation 816 includes, based at least on the RFQ data, generating a CCS referencing the GSID. This can be accomplished, for example, by the user clicking on a GUI control (e.g., Request CCS button 436). In some examples, the CCS comprises a spreadsheet having at least one cell selected from the list consisting of a logical function cell and a formula cell. In some examples, an email message is automatically generated, with the CCS attached. The message may include a style description in the subject line, and the body of the message may contain style details such as department, season, year, and product description, along with last year and last season style details, if available.

Operation 818 includes transmitting the CCS to at least one remote node across a computer network. Additionally, the CCS request can also be forwarded to a supervisory or other monitoring node. In operation 820, the user optionally receives a CCS request summary after all the messages are sent to the bidders. Operation 822 includes the CSS tool tracking a CCS response. For example a tracking and audit function will monitor for the reception of completed CCSs from bidders. Meanwhile, bidders (potential suppliers) complete their CCS forms in operation 824, and submit them in operation 826. In some examples, bidders can directly send the completed CSSs by clicking on a submit button within a CCS form. Operation 828 then includes receiving a completed copy of the CCS containing current product information, and operation 830 includes storing the completed CCS in a data store. In some examples, historical product information is also stored within the data store. In greater detail, for some examples, the submitted completed CCSs are placed into a shared folder, for access by the CSS tool and movement into the data store.

Users are alerted to the received completed CSSs in operation 832, for example by the tacking and audit function of the CSS tool that had been tracking a CSS response in operation 822. Alerts may be sent to a specific user or multiple users, for example, by using an email distribution list. The user then opens the negotiation tool, in operation 834, to review the bids. Operation 836 includes linking the current product information with historical product information, so that the user can readily see relevant changes from the prior year or season. In some examples, the CSS tool uses an ID value (e.g., GSID 430) to accomplish the linking, whereas in other examples, the CSS tool uses a product description to accomplish the linking. This linking facilitates a ready comparison. Operation 838 includes, based on the current product information in the completed CCS, generating a comparison of the current product information with historical product information. So, for example, the CCS tool adds in LY/LS prices, so that the user can see the values. In some examples, the comparison includes calculation of a change, such as amount or percentage change in the prices. In some examples, the user opens a retrieve style screen to see the comparison information.

The user then decides, in decision operation 840, whether to negotiate with one or more bidders, based at least in part on the comparison of operation 838. For example, users can negotiate RFQ terms, including price, with bidders. In the event of a negotiation, whether new or ongoing from a prior iteration, the user enters comments to a bidder, in operation 842. Operation 844 includes transmitting a request for an updated CCS, and flow chart 800 returns to operation 822. When a negotiation is complete (or not begun), a final report is created in operation 846. Operation 848 includes an audit tool (for example, part of tracking and audit function 310) performing audits on a regular basis and/or based at least on a trigger criteria. In some examples, the audit tool is fully automated and sends emails to one or more associates (for example, an associate identified by associate ID 422) to confirm that data is complete and accurate. Operation 850 then optionally includes mining RFQ data collected through CSSs analysis.

In some examples, the operations illustrated in flow chart 800 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements. While the aspects of the disclosure have been described in terms of various examples with their associated operations, a person skilled in the art would appreciate that a combination of operations from any number of different examples or some reordering is also within scope of the aspects of the disclosure.

### Exemplary Operating Environment

FIG. 9 is a block diagram of an example computing device 900 for implementing aspects disclosed herein. That is, computing device 900 may comprise a computer storage device having computer-executable instructions stored thereon for generating customized alerts with CV and ML, which, on execution by a computer, cause the computer to perform operations described herein. Computing device 900 is one example of a suitable computing environment and is not intended to suggest any limitation as to the scope of use or functionality of the invention. Neither should the computing device 900 be interpreted as having any dependency or requirement relating to any one or combination of components/modules illustrated.

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments, where tasks are performed by remote-processing devices that are linked through a communications network.

Computing device 900 includes a bus 910 that directly or indirectly couples the following devices: memory 912, one or more processors 914, one or more presentation components 916, input/output (I/O) ports 918, I/O components 920, a power supply 922, and a network component 924. Computing device 900 should not be interpreted as having any dependency or requirement related to any single component or combination of components illustrated therein. While computing device 900 is depicted as a seemingly single device, multiple computing devices 900 may work together and share the depicted device resources. That is, one or more computer storage devices having computer-executable instructions stored thereon may perform operations disclosed herein. For example, memory 912 may be distributed across multiple devices, processor(s) 914 may provide housed on different devices, and so on.

Bus 910 represents what may be one or more busses (such as an address bus, data bus, or a combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and the diagram of FIG. 9 is merely illustrative of an exemplary computing device that can be used in connection with one or more embodiments. Distinction is not made between such categories as “workstation,” “server,” “laptop,” “hand-held device,” etc., as all are contemplated within the scope of FIG. 9 and the references herein to a “computing device.” Memory 912 may include any of the computer-readable media discussed herein. Memory 912 may be used to store and access instructions configured to carry out the various operations disclosed herein. In some examples, memory 912 includes computer storage media in the form of volatile and/or nonvolatile memory, removable or non-removable memory, data disks in virtual environments, or a combination thereof

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represent an implementation of analog techniques to perform the operations described herein. For example, the operations may be performed by an analog client computing device 900 and/or a digital client computing device 900.

Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. Ports 918 allow computing device 900 to be logically coupled to other devices including I/O components 920, some of which may be built in. Examples I/O components 920 include, for example but without limitation, a microphone, keyboard, mouse, joystick, game pad, satellite dish, scanner, printer, wireless device, etc.

In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, the network component 924 is operable to communicate data over public, private, or hybrid (public and private) using a transfer protocol, between devices wirelessly using short range communication technologies (e.g., near-field communication (NFC), Bluetooth® branded communications, or the like), or a combination thereof. Network component 924 communicates over communication link 926 to a cloud resource 928. Various different examples of communication link 926 include a wired connection, wireless connection, and/or a dedicated link, and in some examples, at least a portion is routed through the interne. Various different examples of cloud resource 928 include computational services in support of the functionality described herein. Examples of cloud resource 628 may themselves be assembled using examples of computing node 900.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

### Exemplary Operating Methods and Systems

An exemplary CCS tool comprises: a processor; and a computer-readable medium storing instructions that are operative when executed by the processor to: receive request for quotation (RFQ) data; determine whether the received RFQ corresponds with prior RFQ data; based at least on the received RFQ not corresponding with prior RFQ data, generate a new sourcing identification value (GSID); based at least on the RFQ data, generate a CCS referencing the GSID; transmit the CCS to at least one remote node across a computer network; receive a completed copy of the CCS containing current product information; store the completed CCS in a data store; and based at least on the current product information in the completed CCS, generate a comparison of the current product information with historical product information.

An exemplary method for managing RFQs using CCSs, implemented on at least one processor, comprises: receiving RFQ data; determining whether the received RFQ corresponds with prior RFQ data; based at least on the received RFQ not corresponding with prior RFQ data, generating a new sourcing identification value (GSID); based at least on the RFQ data, generating a CCS referencing the GSID; transmitting the CCS to at least one remote node across a computer network; receiving a completed copy of the CCS containing current product information; storing the completed CCS in a data store; and based at least on the current product information in the completed CCS, generating a comparison of the current product information with historical product information.

One or more exemplary computer storage devices having a first computer-executable instructions stored thereon for managing RFQs using CCSs, which, on execution by a computer, cause the computer to perform operations which may comprise: receiving RFQ data; determining whether the received RFQ corresponds with prior RFQ data; based at least on the received RFQ not corresponding with prior RFQ data, generating a new sourcing identification value (GSID); based at least on the RFQ data, generating a CCS referencing the GSID; transmitting the CCS to at least one remote node across a computer network; receiving a completed copy of the CCS containing current product information; storing the completed CCS in a data store having historical product information; and based at least on the current product information in the completed CCS, generating a comparison of the current product information with the historical product information.

Alternatively, or in addition to the other examples described herein, examples include any combination of the following:
tracking a CCS response;
linking the current product information with historical product information using an ID value;
linking the current product information with historical product information using a product description;
transmitting a request for an updated CCS;
the CCS comprises a spreadsheet having at least one cell selected from the list consisting of a logical function cell and a formula cell; and
the historical product information is stored within the data store.

The order of execution or performance of the operations in examples of the disclosure illustrated and described herein may not be essential, and thus may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A component cost sheet (CCS) tool comprising:
a processor; and
a computer-readable medium storing instructions that are operative when executed by the processor to:
receive request for quotation (RFQ) data;
determine whether the received RFQ corresponds with prior RFQ data;
based at least on the received RFQ not corresponding with prior RFQ data, generate a new sourcing identification value (GSID);
based at least on the RFQ data, generate a CCS referencing the GSID;
transmit the CCS to at least one remote node across a computer network;
receive a completed copy of the CCS containing current product information;
store the completed CCS in a data store; and
based at least on the current product information in the completed CCS, generate a comparison of the current product information with historical product information.

2. The CCS tool of claim 1 wherein the instructions are further operative to:
track a CCS response.

3. The CCS tool of claim 1 wherein the instructions are further operative to:
link the current product information with historical product information using the new GSID value.

4. The CCS tool of claim 1 wherein the instructions are further operative to:
link the current product information with historical product information using a product description.

5. The CCS tool of claim 1 wherein the instructions are further operative to:
transmit a request for an updated CCS.

6. The CCS tool of claim 1 wherein the CCS comprises a spreadsheet having at least one cell selected from the list consisting of:
a logical function cell and a formula cell.

7. The CCS tool of claim 1 wherein the historical product information is stored within the data store.

8. A method for managing requests for quotations (RFQs) using component cost sheets (CCSs), the method comprising:
receiving RFQ data;
determining whether the received RFQ corresponds with prior RFQ data;
based at least on the received RFQ not corresponding with prior RFQ data, generating a new sourcing identification value (GSID);
based at least on the RFQ data, generating a CCS referencing the GSID;
transmitting the CCS to at least one remote node across a computer network;
receiving a completed copy of the CCS containing current product information;
storing the completed CCS in a data store; and
based at least on the current product information in the completed CCS, generating a comparison of the current product information with historical product information.

9. The method of claim 8 further comprising:
tracking a CCS response.

10. The method of claim 8 further comprising:
linking the current product information with historical product information using the new GSID value.

11. The method of claim 8 further comprising:
linking the current product information with historical product information using a product description.

12. The method of claim 8 further comprising:
transmitting a request for an updated CCS.

13. The method of claim 8 wherein the CCS comprises a spreadsheet having at least one cell selected from the list consisting of:
a logical function cell and a formula cell.

14. The method of claim 8 wherein the historical product information is stored within the data store.

15. One or more computer storage devices having computer-executable instructions stored thereon for managing requests for quotations (RFQs) using component cost sheets (CCSs), which, on execution by a computer, cause the computer to perform operations comprising:
receiving RFQ data;
determining whether the received RFQ corresponds with prior RFQ data;
based at least on the received RFQ not corresponding with prior RFQ data, generating a new sourcing identification value (GSID);
based at least on the RFQ data, generating a CCS referencing the GSID;
transmitting the CCS to at least one remote node across a computer network;
receiving a completed copy of the CCS containing current product information;
storing the completed CCS in a data store having historical product information; and
based at least on the current product information in the completed CCS, generating a comparison of the current product information with the historical product information.

16. The one or more computer storage devices of claim 15 wherein the operations further comprise:
tracking a CCS response.

17. The one or more computer storage devices of claim 15 wherein the operations further comprise:
linking the current product information with historical product information using the new GSID value.

18. The one or more computer storage devices of claim 15 wherein the operations further comprise:
linking the current product information with historical product information using a product description.

19. The one or more computer storage devices of claim 15 wherein the operations further comprise:
transmitting a request for an updated CCS.

20. The one or more computer storage devices of claim 15 wherein the CCS comprises a spreadsheet having at least one cell selected from the list consisting of:
a logical function cell and a formula cell.
